(19) United States
(12) Patent Application Publication
(10) Pub. No.: US 2013/0036770 A1
(43) Pub. Date: Feb. 14, 2013

(54) METHOD FOR PRODUCING GLASS BASE MATERIAL

(71) Applicant: Tomohiro Ishihara, Yokohama-shi (JP)

(72) Inventor: Tomohiro Ishihara, Yokohama-shi (JP)

(73) Assignee: SUMITOMO ELECTRIC INDUSTRIES, LTD., Osaka-shi (JP)

(21) Appl. No.: 13/641,981

(22) PCT Filed: May 2, 2011
(86) PCT No.: PCT/JP2011/060560

§ 371 Date: Oct. 18, 2012

(30) Foreign Application Priority Data
Apr. 30, 2010 (JP) 2010-105531
Feb. 28, 2011 (JP) 2011-042132

(51) Int. Cl. C03B 37/018

(52) U.S. Cl. 65/421

(57) ABSTRACT

A glass base material producing method produces a glass base material through fixing, deposition, pullout, consolidation, and collapse steps in sequence, while the fixing step inserts and fixes a starting bar 11 into a seed rod pipe 12 such that a leading end part 11a of the starting bar 11 projects from one end 12a of the seed rod pipe 12, thereby making a starting rod 10. The starting rod 10 made in the fixing step Si yields a level difference of at least 0.1 mm but not exceeding 0.5 mm at the one end 12a of the seed rod pipe 12. Fine glass particles are deposited on the seed rod pipe in the deposition step in an axial range of at least 50 mm from a position where the level difference exists.

### TECHNICAL FIELD

The present invention relates to a method for producing a glass base material for an optical fiber.

### BACKGROUND ART

An optical fiber is produced by heating one end of a glass base material, which has a substantially columnar form, so as to soften it and drawing the same. Glass base materials for optical fibers are manufactured by methods such as OVD and MCVD processes. Patent Literature 1 discloses a glass base material producing method based on the OVD process.

The glass base material producing method disclosed in Patent Literature 1, which intends to manufacture a glass base material for an optical fiber having a low water content, deposits fine particles of glass on the outer periphery of a starting rod formed by inserting a starting bar into a seed rod pipe, so as to make a deposit of fine glass particles, and pulls the starting bar out of the deposit of fine glass particles, so as to yield a deposit of fine glass particles having a center hole extending axially therethrough. The resulting deposit of fine glass particles is heated, so as to dry and consolidate it, and the center hole is closed, so as to produce a transparent glass base material.

### CITATION LIST

### Patent Literature

Patent Literature 1: Japanese Translated International Application Laid-Open No. 2002-543026
Patent Literature 2: U.S. Pat. No. 4,289,522

### SUMMARY OF INVENTION

### Technical Problem

In the glass base material producing method disclosed in Patent Literature 1, during the deposition step of making the deposit of fine glass particles by depositing the fine glass particles on the outer periphery of the starting rod, the starting rod and a burner for synthesizing the fine glass particles are moved relative to each other to and fro axially of the starting bar, so as to deposit the fine glass particles on the outer periphery of the starting rod from a leading end portion of the starting bar to a part of the seed rod pipe, thereby making the deposit of fine glass particles. Patent Literature 2 includes a description concerning the leading end form of the seed rod in the similar glass base material producing method and states that the leading end of the seed rod is preferably thin. When such a deposition step makes the deposit of fine glass particles, however, the deposit of fiber glass particles may break, thereby worsening the yield in producing glass base materials.

For solving the problem mentioned above, it is an object of the present invention to provide a method which can produce glass base materials with high yield.

### Solution to Problem

The glass base material producing method in accordance with the present invention comprises (1) a fixing step of inserting and fixing a starting bar into a seed rod pipe such that a leading end part of the starting bar projects from one end of the seed rod pipe, so as to make a starting rod; (2) a deposition step of moving the starting rod and a burner for synthesizing fine particles of glass relative to each other to and fro axially of the starting bar after the fixing step, so as to deposit the fine particles of glass on an outer periphery of the starting rod from the leading end part of the starting bar to a part of the seed rod pipe, thereby making a deposit of fine glass particles; (3) a pullout step of pulling the starting bar out of the seed rod pipe and deposit of fine glass particles after the deposition step; (4) a consolidation step of heating the deposit of fine glass particles after the pullout step, so as to make a transparent glass tubing; and (5) a collapse step of heating the transparent glass tubing while depressurizing the inside thereof after the consolidation step, so as to make a solid glass base material. The glass base material producing method in accordance with the present invention is characterized in that the starting rod made in the fixing step yields a level difference of at least 0.1 mm but not exceeding 0.5 mm at the one end of the seed rod pipe and that the fine glass particles are deposited on the seed rod pipe in the deposition step in an axial range of at least 50 mm from a position where the level difference exists.

### Advantageous Effects of Invention

The glass base material producing method in accordance with the present invention can produce glass base materials with high yield.

### BRIEF DESCRIPTION OF DRAWINGS

FIG. 1 is a flowchart of the glass base material producing method in accordance with an embodiment;

FIG. 2 is a view for explaining a fixing step S1 in the glass base material producing method in accordance with the embodiment;

FIG. 3 is a view for explaining a deposition step S2 in the glass base material producing method in accordance with the embodiment;

FIG. 4 is a view for explaining a pullout step S3 in the glass base material producing method in accordance with the embodiment;

FIG. 5 is a view for explaining a consolidation step S4 in the glass base material producing method in accordance with the embodiment;

FIG. 6 is a view for explaining a collapse step S5 in the glass base material producing method in accordance with the embodiment;

FIG. 7 is a view for explaining a level difference at one end 12a of a seed rod pipe 12 in the glass base material producing method in accordance with the embodiment; and

FIG. 8 is a chart listing level differences and favorable manufacture ratios in examples and comparative examples.

### DESCRIPTION OF EMBODIMENTS

In the following, embodiments for carrying out the present invention will be explained in detail with reference to the accompanying drawings. In the explanation of the drawings, the same constituents will be referred to with the same signs while omitting their overlapping descriptions.

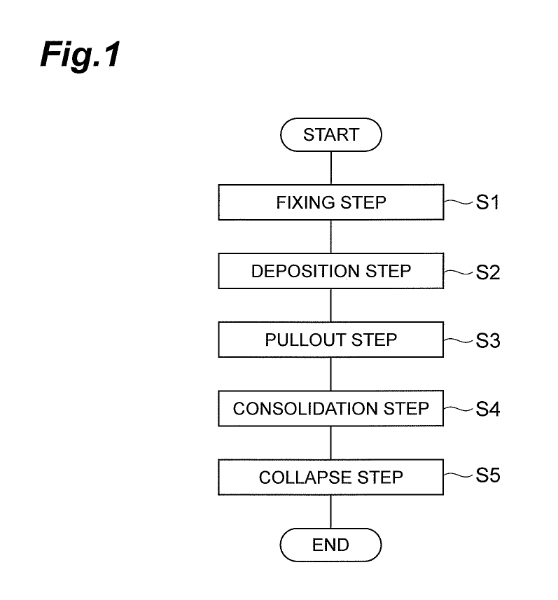

FIG. 1 is a flowchart of the glass base material producing method in accordance with an embodiment. As illustrated in the chart, the glass base material producing method in accordance with this embodiment produces a glass base material through a fixing step S1, a deposition step S2, a pullout step S3, a consolidation step S4, and a collapse step S5 in sequence. The glass base material produced by this glass base material producing method is an optical fiber base material for manufacturing an optical fiber by drawing, for example, or a core base material to become a core part in the optical fiber base material.

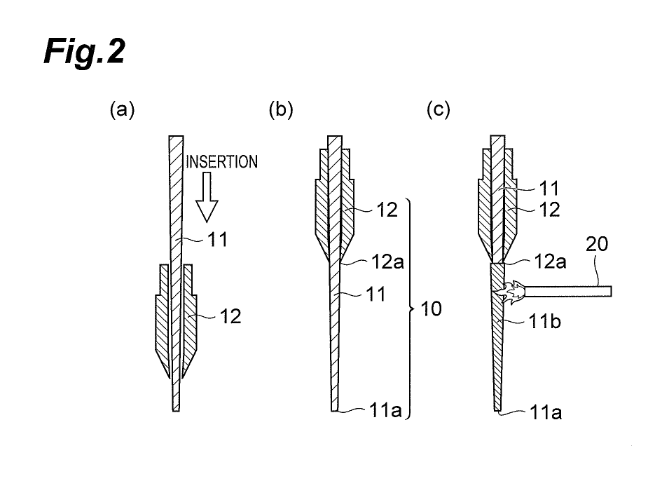

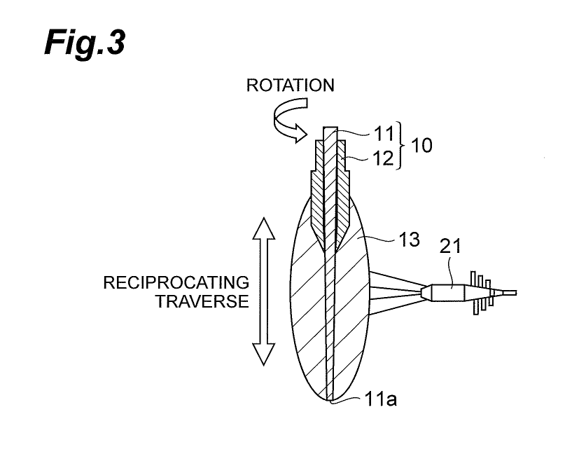

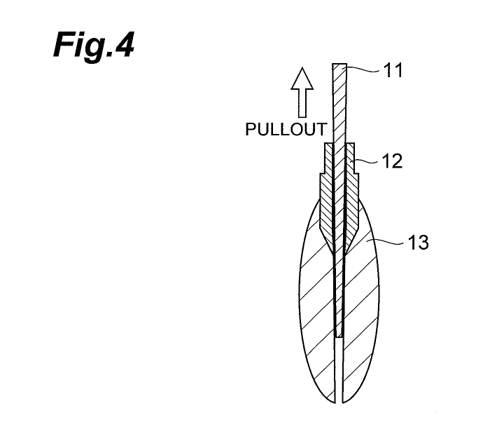

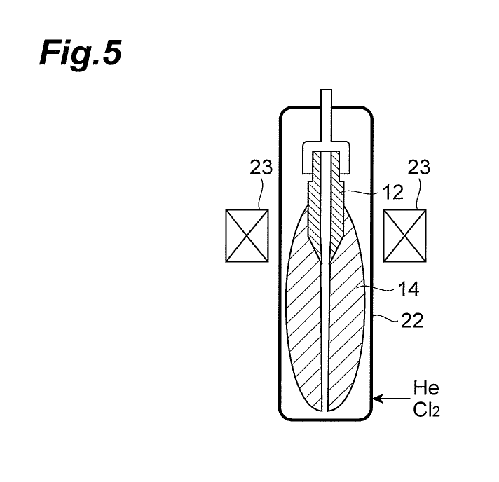

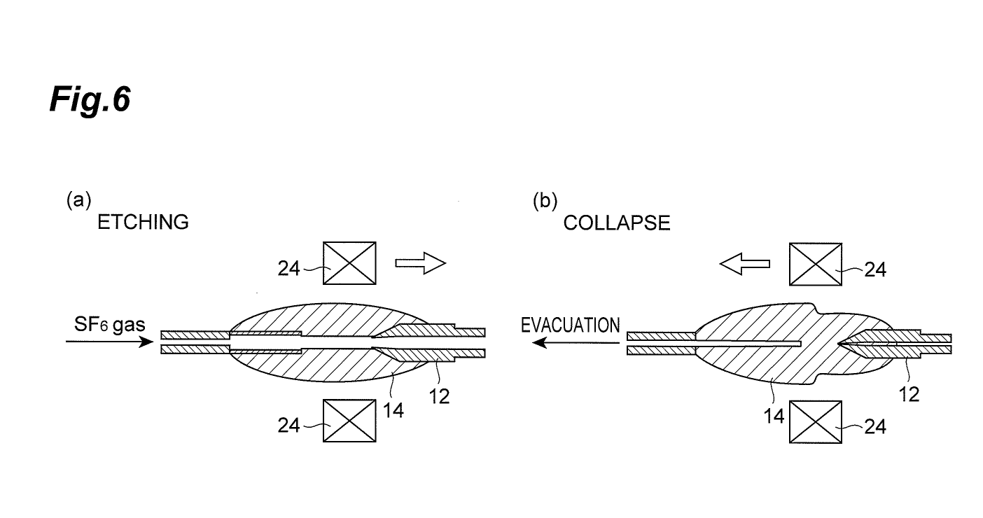

FIG. 2 is a view for explaining the fixing step S1 in the glass base material producing method in accordance with the embodiment. FIG. 3 is a view for explaining the deposition step S2 in the glass base material producing method in accordance with the embodiment. FIG. 4 is a view for explaining the pullout step S3 in the glass base material producing method in accordance with the embodiment. FIG. 5 is a view for explaining the consolidation step S4 in the glass base material producing method in accordance with the embodiment. FIG. 6 is a view for explaining the collapse step S5 in the glass base material producing method in accordance with the embodiment.

The fixing step S1 (FIG. 2) inserts and fixes a starting bar 11 into a seed rod pipe 12 such that a leading end part 11a of the starting bar 11 projects from one end 12a of the seed rod pipe 12, thereby making a starting rod 10 (see (a) and (b) in the figure). The starting bar 11 is made of any of materials such as alumina, glass, refractory ceramics, and carbon, for example. The seed rod pipe 12 is constituted by silica glass. The starting rod 10 made in the fixing step S1 yields a level difference of at least 0.1 mm but not exceeding 0.5 mm at the one end 12a of the seed rod pipe 12.

On the outer periphery of the part of the starting bar 11 projecting from the one end 12a of the seed rod pipe 12 in the starting rod 10, a carbon film 11b is preferably formed by a flame from a burner 20 using a city gas burner, an acetylene burner, or the like ((c) in the figure). During forming the carbon film, the starting rod 10 is rotated about the center axis of the starting bar 11, while the burner 20 repeatedly moves relative to the starting rod 10 to and fro axially of the starting bar 11.

After the fixing step S1, the deposition step S2 (FIG. 3) rotates the starting rod 10, which is formed by inserting and fixing the starting bar 11 into the seed rod pipe 12, about the center axis of the starting bar 11. A fine glass particle synthesizing burner 21, arranged beside the starting rod 10, for forming an oxyhydrogen flame repeatedly moves relative to the starting rod 10 to and fro axially of the starting bar 11. Then, an OVD process deposits fine particles of glass on the outer periphery of the starting rod 10 from the leading end part 11a of the starting bar 11 to a part of the seed rod pipe 12, thereby making a deposit of glass fine particles 13.

The deposition step S2 adjusts a material supply flow rate in the fine glass particle synthesizing burner 21 for each traverse. As a consequence, the fine particles of glass deposited on the starting bar 11 have a predetermined composition distribution radially thereof (i.e., a radial refractive index distribution in a subsequent glass base material or optical fiber).

After the deposition step S2, the pullout step S3 (FIG. 4) pulls the starting bar 11 out of the seed rod pipe 12 and deposit of fine glass particles 13. Here, the seed rod pipe 12 and the deposit of fine glass particles 13 are kept being secured to each other. Forming the carbon film on the outer periphery of the part projecting from the one end 12a of the seed rod pipe 12 in the starting bar 11 after the fixing step S1 prevents the inner wall face of the center hole in the deposit of fine glass particles 13 from being damaged when the pullout step S3 pulls out the starting bar 11.

After the pullout step S3, the consolidation step S4 (FIG. 5) puts the deposit of fine glass particles 13, together with the seed rod pipe 12 integrated therewith, into a heating furnace 22 having He and Cl₂ gases introduced therein and heats them with a heater 23. This makes a transparent glass tubing 14.

After the consolidation step S4, the collapse step S5 (FIG. 6) places and rotates the transparent glass tubing 14 in a heating furnace and heats it while introducing SF₆ into the center hole, so that the inner wall face of the center hole is subjected to gas-phase etching ((a) in the figure). Subsequently, the transparent glass tubing 14 is heated with a heater 24 while being depressurized therewithin, so as to be consolidated ((b) in the figure), whereby a solid glass base material is made.

Thus produced transparent glass base material is further furnished with a cladding layer formed and transparentized thereon and so forth, so as to yield a preform, and its leading end is then heated and softened, so as to be drawn, whereby an optical fiber is produced.

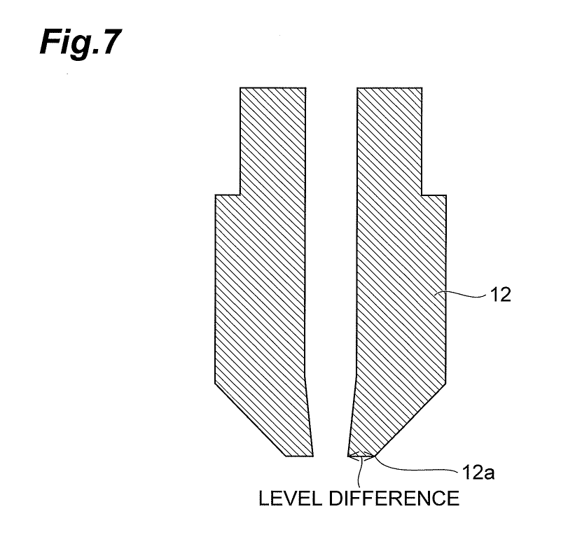

The level difference (see FIG. 7) of the starting rod 10 made in the fixing step 51 at the one end 12a of the seed rod pipe 12 is at least 0.1 mm but not exceeding 0.5 mm in this embodiment. When the level difference exceeds 0.5 mm, fine particles of glass will not deposit on the level difference part even if the deposition of fine glass particles proceeds, thereby increasing the differences in outer diameter and density between the level difference and favorable product parts, which finally makes it easier for the level difference part to break. When the level difference is 0.5 mm or less, by contrast, the deposit of fine glass particles is inhibited from breaking, whereby glass base materials can be produced with high yield. The level difference, which is preferably as small as possible but technically hard to process into less than 0.1 mm, also makes the one end 12a of the seed rod pipe 12 poor in strength and easy to break upon manufacture or in use when processed into less than 0.1 mm. Therefore, it is preferred for the level difference to be 0.1 mm or greater. On the other hand, the fine glass particles are deposited on the seed rod pipe in the deposition step in an axial range of at least 50 mm from a position where the level difference exists. When the range is less than 50 mm, the bonding force between the deposit of fine glass particles and the seed rod pipe becomes weaker, so that the deposit of fine glass particles is easier to peel off from the seed rod pipe.

An example of the glass base material producing method in accordance with the embodiment will now be explained. This example produces a glass base material for manufacturing a graded-index-type optical fiber by drawing.

In the deposition step S2, an OVD system is used for depositing fine particles of glass. As the starting bar 11, one made of alumina having an outer diameter of 9 to 10 mm and a length of 1200 mm is used. As the seed rod pipe 12, one made of silica glass having a length of 600 mm, an outer diameter of 20 to 40 mm, and an inner diameter of 9.8 to 21 mm is used.

The glass material gases introduced into the fine glass particle synthesizing burner 21 for forming the oxyhydrogen flame in the deposition step S2 are SiCl₄ (by an amount of 1 to 3 SLM/piece) and GeCl₄ (by an amount of 0.0 to 0.3 SLM).

A level difference of 0.1 to 0.5 mm is generated at the one end 12a of the seed rod pipe 12. The relative moving speed of the starting rod 10 with respect to the fine glass particle synthesizing burner 21 is 500 to 1500 mm/min.

After thus configured deposition step S2, the pullout step S3 and consolidation step S4 are performed before the collapse step S5. In the collapse step S5, the transparent glass tubing 14 is placed in a heating furnace and rotated at 30 rpm, while being heated to a temperature of 1900 to 2200° C. by a heating furnace moving longitudinally of the transparent glass tubing 14 at a speed of 5 to 20 mm/min. Here, oxyhydrogen burner lathes may be used as heating means in the collapse step S5 instead of heating furnaces using carbon heaters, heating elements based on electromagnetic induction coils, and the like. At this time, an SF₆ gas flows at 50 to 100 sccm through the center hole of the transparent glass tubing 14, whereby the inner wall face of the center hole of the transparent glass tubing 14 is subjected to gas-phase etching.

Subsequently, the transparent glass tubing 14 is depressurized to 0.1 to 10 kPa within its center hole, so as to be consolidated, at the same temperature as that at the time of etching, whereby a glass base material is produced.

Thus produced glass base material is extended so as to yield a desirable diameter, and jacket glass is synthesized on its outer periphery by the OVD process, so as to produce a glass base material for an optical fiber. This glass base material for an optical fiber is drawn, so as to produce a multimode fiber of a graded index type.

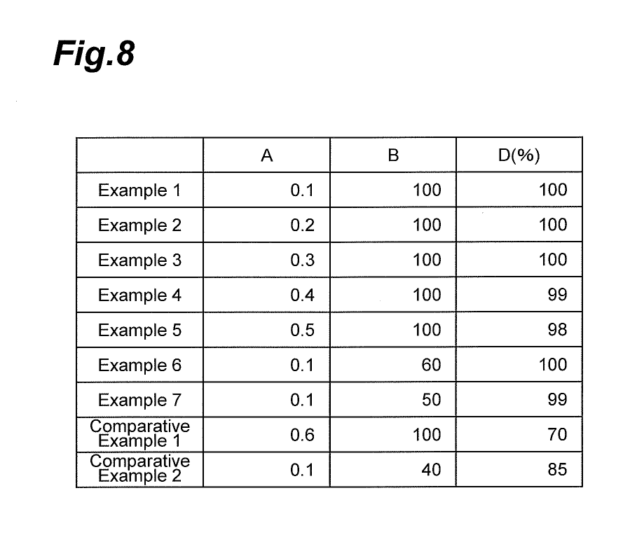

FIG. 8 is a chart listing level differences and favorable manufacture ratios in examples and comparative examples. Here, letting the level difference A at the one end 12a of the seed rod pipe 12 in the starting rod 10 made by the fixing step Si vary from 0.1 to 0.6 mm, while the range B in which fine particles of glass deposit on the seed rod pipe 12 is 40 to 100 mm, a favorable manufacture ratio D (%) at which no breakage occurs in the deposit of fine glass particles is comparatively evaluated. As this chart illustrates, the favorable manufacture ratio D is only 70% when the level difference A is 0.6 mm, but is 98 to 100% when the level difference A is 0.1 to 0.5 mm, whereby glass base materials can be produced with high yield. Even at the level difference A of 0.1 mm, the favorable manufacture ratio D is only 85% when the range B for deposition on the seed rod pipe is only 40 mm, but is 99% or greater when the range B is at least 50 mm, whereby glass base materials can be produced with high yield.

### INDUSTRIAL APPLICABILITY

The present invention can provide a method which can produce glass base materials with high yield.

### REFERENCE SIGNS LIST

10 . . . starting rod; 11 . . . starting bar; 12 . . . seed rod pipe; 13 . . . deposit of fine glass particles; 14 . . . transparent glass tubing; 20 . . . burner; 21 . . . fine glass particle synthesizing burner; 22 . . . heating furnace; 23, 24 . . . heater

1. A glass base material producing method comprising:
a fixing step of inserting and fixing a starting bar into a seed rod pipe such that a leading end part of the starting bar projects from one end of the seed rod pipe, so as to make a starting rod;
a deposition step of moving the starting rod and a burner for synthesizing fine particles of glass relative to each other to and fro axially of the starting bar after the fixing step, so as to deposit the fine particles of glass on an outer periphery of the starting rod from the leading end part of the starting bar to a part of the seed rod pipe, thereby making a deposit of fine glass particles;
a pullout step of pulling the starting bar out of the seed rod pipe and deposit of fine glass particles after the deposition step;
a consolidation step of heating the deposit of fine glass particles after the pullout step, so as to make a transparent glass tubing; and
a collapse step of heating the transparent glass tubing while depressurizing the inside thereof after the consolidation step, so as to make a solid glass base material;
wherein the starting rod made in the fixing step yields a level difference of at least 0.1 mm but not exceeding 0.5 mm at the one end of the seed rod pipe, while the fine glass particles are deposited on the seed rod pipe in the deposition step in an axial range of at least 50 mm from a position where the level difference exists.
